(19) United States
(12) Patent Application Publication
(10) Pub. No.: US 2022/0395788 A1
(43) Pub. Date: Dec. 15, 2022

(54) MUD MIXING SYSTEM AND METHOD OF USE

(71) Applicant: Daniel Howell, Bailey, CO (US)

(72) Inventor: Daniel Howell, Bailey, CO (US)

(21) Appl. No.: 17/890,624

(22) Filed: Aug. 18, 2022

Related U.S. Application Data
(62) Division of application No. 16/410,238, filed on May 13, 2019, now abandoned.
(60) Provisional application No. 62/670,674, filed on May 11, 2018.

(51) Int. Cl. B01F 33/25; B01F 23/50; B01F 31/20; B01F 33/501; B01F 35/51; B01F 35/45

(52) U.S. Cl. CPC B01F 33/253; B01F 23/59; B01F 23/511; B01F 31/201; B01F 33/50111; B01F 35/51; B01F 35/451; B01F 23/581

(57) ABSTRACT

A system and method for mud mixing using a container to hold a joint compound and the water. The container having a lid to keep the container shut and preventing the liquids from escaping wherein the container may then be shaken by the user to mix the joint compound with the water. The user then may remove lid and pull on a rod and plate connected to one another at the bottom of holding container. Rod and plate act as a pressure seal, whereby when the rod is pulled all of the mud may be removed from the container and placed into a pan for use.

### CROSS-REFERENCE TO RELATED APPLICATIONS

This application claims priority to a prior-filed nonprovisional application Ser. No. 16/410,238 filed May 13, 2019 which claims priority to provisional application Ser. No. 62/670,674 filed on May 11, 2018.

### FIELD OF DISCLOSURE

The overall field of this invention is a system and method for mixing water and joint compound. More specifically the field of the invention is a self-contained apparatus for mixing powdered joint compound and water to produce mud for drywall texturing and other applications.

### BACKGROUND

Mudding is the process of applying a series of thin coats of mud containing a mixture of water and joint compound. The mixture may be applied to the screw or nail indentations and joints in drywall and plaster, as well as to adhere paper joint tape, fill joints, and to top paper and mesh joint tapes, as well as plastic and metal corner beads. With respect to its application to drywall, when correctly applied the wall appears perfectly smooth having seams that are not visible to the naked eye. Once the finished drywall surface has been coated with the mud, the drywall is ready for paint or a textured finish.

There are predominately two types of mud currently being used, premixed mud (or ready mix) and powdered mud. Premixed mud is mud where the joint compound have already been mixed with water to a uniform consistency. Premixed mud may be applied to the drywall or used in another manner without having to additionally mix the mud together. Premixed mud, which includes the joint compound, is designed for fast application and easy maintenance. While there are advantages for premixed mud, including the time saved in mixing and preparing the mud, there are also some disadvantages. Premixed mud, though takes long periods of time to dry and shrinks more than powdered mud. Premixed mud is also more expensive to purchase than the dry, powered mix. Additionally, pre-mixed mud is also unable to be recoated within a 18 hour period, which can lead to excessive time and delays for a project.

Powdered mud is mud that contains dry joint compound. When water is added, the dry joint compound becomes a useable mud for to hasten hardening time. Powdered mud is useful for filling in small gaps where you do not want to wait long periods of time before applying a second coat and also useful for fully covering joints in a day. Powdered mud also provides a stronger base coat, which may prevent cracking. This is useful when finishing corners.

One of the issues with powered mud is that powdered mud hardens very quickly. Powdered mud is typically labeled the by the maximum amount of time the mud is usable before it hardens such as 5 minutes, 10 minutes, 20 minutes, 45 minutes, 90 minutes or longer. Painters and tradesman spend countless hours working, mixing mud with water to fix imperfections in the drywall. The process to mix powdered mud involves pouring powder into a pan, then adding water and mixing the compound with a putty knife until the desired consistency is reached. This method of mixing one pan at a time, spreading the mud, then mixing another pan is very long and strenuous, leading to fatigue, inconsistent mud mixing, and longer time labor times for the painter or tradesman. Thus, there still exists a need for a system and method to mix joint compound with water in a consistent manner to form mud in a way that is inexpensive to produce and cuts down on labor time.

### SUMMARY

Embodiments in the present description are directed to an apparatus for forming a mud mixture, the apparatus comprising, a holding container with an opening at the top, an inner surface, a closed bottom surface, and a bore extending through the holding container, a plate positionable within the holding container, the plate having a hole located on the plate, a rod, the rod having a first end insertable into the hole of the plate, the plate moveable in a reciprocating motion within the holding container when connected to the rod, a lid, the lid securable to the holding container, the lid configured to cover the opening at the top of the holding container, wherein the mud mixture is comprised of a joint compound and water, wherein joint compound is a 5 minute, 20 minute, 45 minute, 90 minute powdered mix or dry powdered mixture, the holding container having a generally cylindrical shape, wherein the hole is centrally located on the plate, the lid and holding container rotatably movable with respect to another from a first a closed position to an open position whereby the closed position creates a seal preventing liquid from escaping the holding container, the bottom closed end of the holding container having a substantially hemispherical shape, an outer diameter of the plate and an inner surface of the holding container forming a static and dynamic seal to prevent leakage between the plate and the holding container, the lid having a substantially circular body having a slightly greater diameter than the holding container allowing for centering the lid over the opening in the holding container and thereafter engaging the lid to secure the lid in place on top of the holding container, the plate made of stainless steel with the outer diameter made of rubber. a hinge, the hinge connecting the lid the holding container, the hinge having two leaves, the leaves connected by a hinge pin inserted through the hinge leafs, one leaf attached to holding container projecting laterally outwardly from holding container 110, one leaf attached to lid, a removable divider insertable into the holding container to separate the joint compound and water.

It is an object of the present description to provide a method for forming a mud mixture of joint compound and water, the method comprising, placing the joint compound and the water in a holding container, the holding container having a generally cylindrical shape with an opening at the top, an inner surface, a closed bottom surface, and bore extending through the holding container, closing a lid, wherein the lid fits securely over the top of the holding container, shaking the holding container in order to combine the joint compound and the water into a resulting mud mixture, opening the lid, pulling on a rod located within the holding container, wherein the rod is connected to a plate, wherein the plate and the rod are moveable in a reciprocating motion within the holding container, further comprising pouring the mud mixture out of the holding container, further comprising pouring the mud mixture into a pan, further comprising dividing the water and the joint compound, the divider inserting in the holding container to separate the joint compound and water, further comprising removing the divider, further comprising cleaning the holding container, wherein the steps to clean the holding container comprise filling the holding container with an amount of water, replacing the lid on top of the holding container, shaking the holding container, removing the lid from the holding container, and ejecting any remnants from the holding container.

### BRIEF DESCRIPTION OF DRAWINGS

The present invention will be described by way of exemplary embodiments, which are meant to be illustrative but not restrictive as to the scope of the present invention, illustrated in the accompanying drawings in which like references denote similar elements, and in which:

FIG. 1A shows a top view of the inside of a mud mixing system in the open position without a lid.

FIG. 1B shows a front view of the inside of the mud mixing system shown in FIG. 1A in the open position.

FIG. 2 shows a front view of the mud mixing system in the closed position with lid attached.

FIG. 3 shows a top view of the mud mixing system in the open position with the lid attached by a hinge.

FIG. 4 shows a front view of the rod and the plate of the mud mixing system moving in an upward direction within the holding container.

FIG. 5 shows a flow chart for an exemplary method of using the mud mixing system.

FIG. 6 shows a front view of the water and joint compound poured into the mud mixing system and pushed out when the rod and the plate move upward.

FIG. 7 shows a perspective view of the produced mixture being poured from the mud mixing system into a pan.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects.

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items,” may indicate the presence of only one item, or may indicate more items. Thus, the term “set” may be equivalent to “one or more” as used herein.

In the following detailed description, numerous specific details are set forth in order to provide a more thorough understanding of the one or more embodiments described herein. However, it will be apparent to one of ordinary skill in the art that the invention may be practiced without these specific details. In other instances, well-known features have not been described in detail to avoid unnecessarily complicating the description.

The present disclosure recognizes the unsolved need for a mud mixing system and method of use that delivers a consistent and continuous form of mud, while keeping operation time and wasted mud to a minimum. The mud mixing system uses a container to hold the joint compound and the water. The container may have a lid, sealing the container shut and preventing the liquids from escaping. The mud mixing system may then be shaken by the user to mix the joint compound with the water. The user then may release lid and pull on rod and plate at the bottom of holding container. Rod and plate act as a pressure seal, whereby when pulled all of the mud may be removed from the container and placed into a pan for use. The mud mixing system improves on the currently used practices that require the user to stir the joint compound and water in a pan or complicated machinery. The mud mixing system keeps labor time to a minimum while preventing waste of mud. The mud mixing system also delivers consistently produced mud with minimum effort by the user.

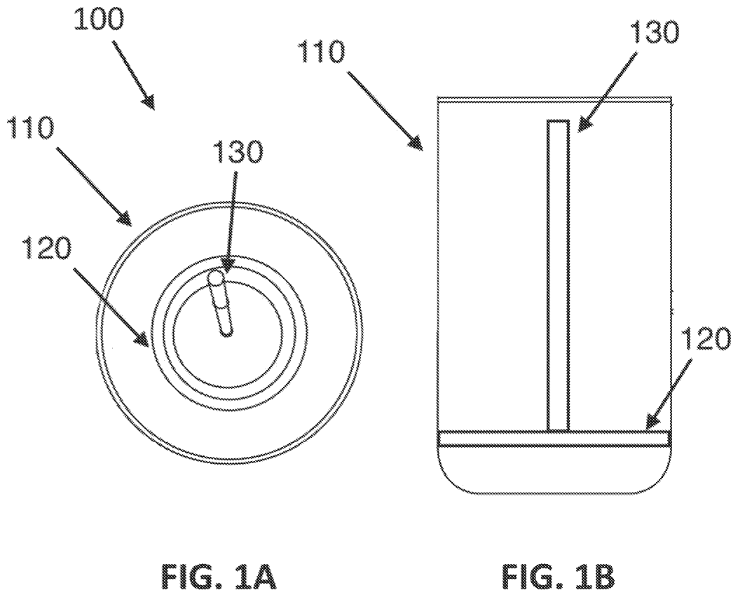

With reference now to FIG. 1A-1B, one exemplary embodiment of mud mixing system 100, according to the present invention is generally designated. Mud mixing system 100 may include a holding container such as holding container 110 for receiving and holding powdered material and water whereby substances such as joint compound and water may be mixed together within holding container 110 and poured out into a pan or other apparatus. The joint compound used may be any type of joint compound known by one of ordinary skill in the art such as 5 minute, 20 minute, 45 minute, 90 minute powdered mix, such as USG sheetrock durabond, and may also be described as a dry powdered mixture.

Holding container 110 may be container for holding the combination of joint compound and water for mixing purposes. In one exemplary embodiment, holding container 110 may have having a hollow cylindrical body with sidewalls and a bottom closed end. In one embodiment, the bottom closed end may have a substantially hemispherical shape as shown in FIGS. 1A and 1B. The shape of holding container 110 is non-limiting and in some embodiments may be cylindrical shaped, oval-shaped, spherical shaped, or any other shape as known in the art. Further, holding container 110 may preferably be made of stainless steel. Alternatively, holding container 110 may be composed of any metal such as brass, copper, nickel, chromium, or any other types of metals and/or alloys.

The mud mixing system may have an internal plate surface, plate such as plate 120 as depicted in FIG. 1A and FIG. 1B positioned within holding container 110. Plate 120 may be circular in shape and has an outer diameter, such that plate 120 may be inserted in holding container 110 and may also be slideable within holding container 110 in an upwards or downwards direction. The outer diameter of plate 120 is either equal to or slightly smaller than an inner diameter of holding container 110 such that plate 120 does not move relative to holding container unless an external force is applied to plate 120 (e.g. such as by connecting rod 130 shown in FIGS. 1A and 1B to a central hole within plate 120 and moving plate 120 in an upwards or downwards direction within the interior hollow space of holding container 110). The outer diameter of plate 120 and inner surface of holding container 110 form a static and dynamic seal to prevent leakage of any fluid between plate 120 and holding container while plate 120 and holding container 110 are stationary or when plate 120 is moved in a sliding motion along the inner surface of holding container 110. Plate 120 is preferably made of stainless steel with the outer diameter made of rubber, but in other non-limiting embodiments, plate 120 may be completely made of rubber or made of any pliable material capable of sealing two mechanisms such as plastic or Teflon. Further, in one embodiment, plate 120 has a hole that is centrally located on plate 120, which may be sized to fit rod 130. plate

As depicted in FIGS. 1A and 1B, rod 130 may be a generally elongated rod having a first end whereby the first end may be inserted into the hole of plate 120, creating a seal so that any liquid may not enter into the hole. Rod 130 may be thin and cylindrical in shape. A top end of rod 130 may terminate before the top end reaches the top surface of holding container 110, in one embodiment. Rod 130 may extend into holding container 110 and be generally parallel to the sidewalls of holding container 110.

In one embodiment, plate 120 and rod 130 are configured to be joined together. For example, rod 130 may be insertable within a hole (e.g. a centrally located hole) on plate 120 such that the rod 130 fits tightly and securely within the hole on plate 120. Alternatively, rod 130 may be welded, soldered, or otherwise attached to plate 120. In still other embodiments, rod 130 may include threads located on a lower outside end of rod 130 that may be threadingly engaged and mated with their counterparts located in the hole in plate 120. Accordingly, the application of torque to a threaded rod, such as rod 130 in such an exemplary embodiment, may be used to easily turn and tighten in place rod 130 and then to remove rod 130 as well by turning in a counter direction.

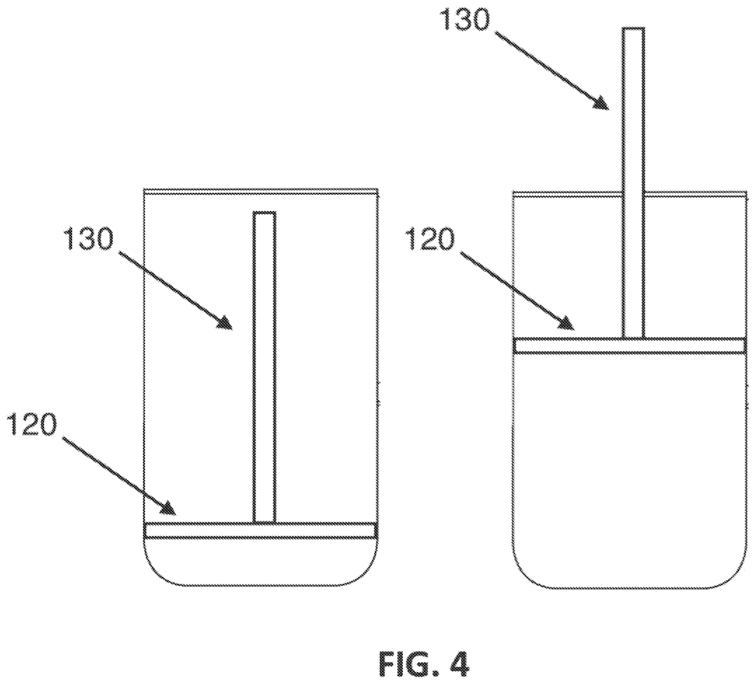

Rod 130 is preferably made of stainless steel but may be composed of any rigid metal such as brass, copper, nickel, chromium, or other metals and alloys. In some embodiments, rod 130 may have a handle connected to rod 130 to provide for the facilitation of gripping rod 130. In some embodiments, rod 130 may be detachable from plate 120. FIG. 4 depicts the sliding motion of rod 130 and plate 120 along the inner surface of holding container 110. Thus, plate 120 may be coupled to a bottom end or first end of rod 130 and may be raised and lowered within the holding container 110. There may be a maximum point that plate 120 may be raised within holding container 110 or, alternatively, the plate 120 may be raised to the topmost surface of holding container 110 and removed as needed from holding container 110. Further, there may be a maximum distance within holding container 110 that plate 120 may be lowered, or alternatively, plate 120 may be lowered completely within holding container 110 so as to make contact with the inner surface of holding container's 110 bottom surface.

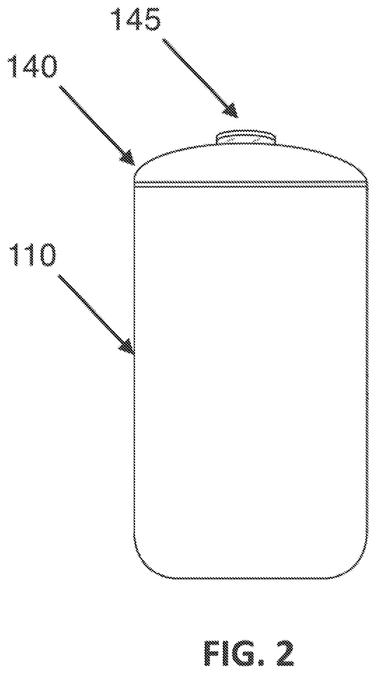

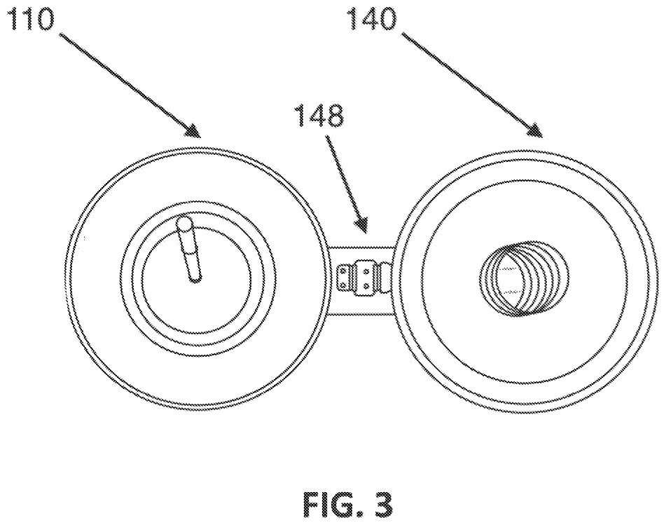

In some embodiments, the mud mixing apparatus (e.g. holding container 110) may have a lid such as lid 140 as depicted in FIG. 2. Lid 140 may have a handle such as handle 145. Lid 140 may have a substantially circular body having a slightly greater diameter than holding container 110 opening allowing for centering lid 140 over the opening in holding container 110 and thereafter engaging lid 140 to secure lid 140 in place on top of holding container. This engagement applies a radial force inward from lid 140 to the outer surface of holding container 110 and against the inside surface of the of holding container 110 to create a substantially liquid-tight seal that prevents the exiting of liquids from holding container 110. Lid 140 may be removed by applying a force greater than the radial force such as a user pulling on the handle away from holding container 110.

Lid 140 and holding container 110 may be rotatably movable with respect to another from a first a closed position to an open position whereby the closed position creates a seal preventing liquid from escaping holding container 110. Lid 140 may have a series of downwardly directed, cylindrical projections guiding relative rotation of lid 140 and holding container 110. Holding container 110 may also have internal threading adapted for mating with the corresponding cylindrical projections on lid 140. In some embodiments, there may be one or more stopping members to discourage inadvertent rotation of lid 140 in a direction from the closed position to position unless sufficient torque is applied to lid 140 whereby the stopping member may be deformed and lid 140 may pass over it.

In some embodiments, a hinge such as hinge 148 may connect lid 140 to holding container 110. Hinge 148 may include two leaves, the leaves connected by a hinge pin inserted through the hinge leafs. One leaf may be attached to holding container 110 projecting laterally outwardly from holding container 110, and another leaf may be attached to lid 140 projecting laterally outwardly from lid 140, whereby lid 140 may thereby be raised and lowered from holding container 110 by rotation about the hinge pin.

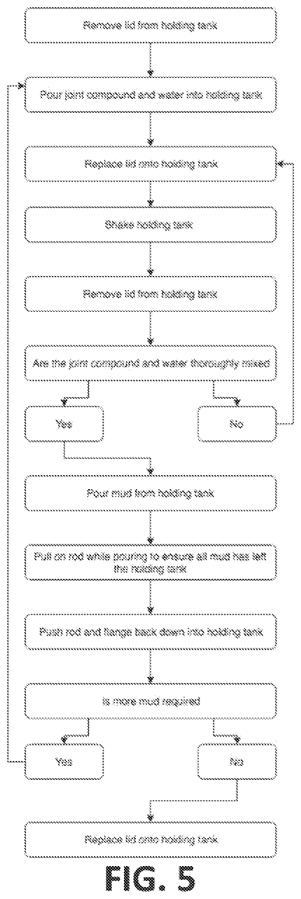

In an exemplary method of use as shown in FIG. 5, lid 140 is first removed from holding container 110. A user may add the joint compound and water to the holding container 110 through the opening at the top. The amount of water to be added and the amount of joint compound may be selected by the user depending on the quantity of mud needed by the user. Lid 140 is then replaced back onto the top of holding container 110, sealing the water and joint compound inside. Force is then applied manually by the user in the form of rolling, shaking, pulling or twisting the mud making system, mixing the water and joint compound together, thereby forming the mud mixture. Lid 140 is then removed from holding container 110. User may check to see the water and joint compound are properly mixed. If not, the user may once again replace lid 140 and shake the holding container 110 until a sufficient amount of mixing has occurred.

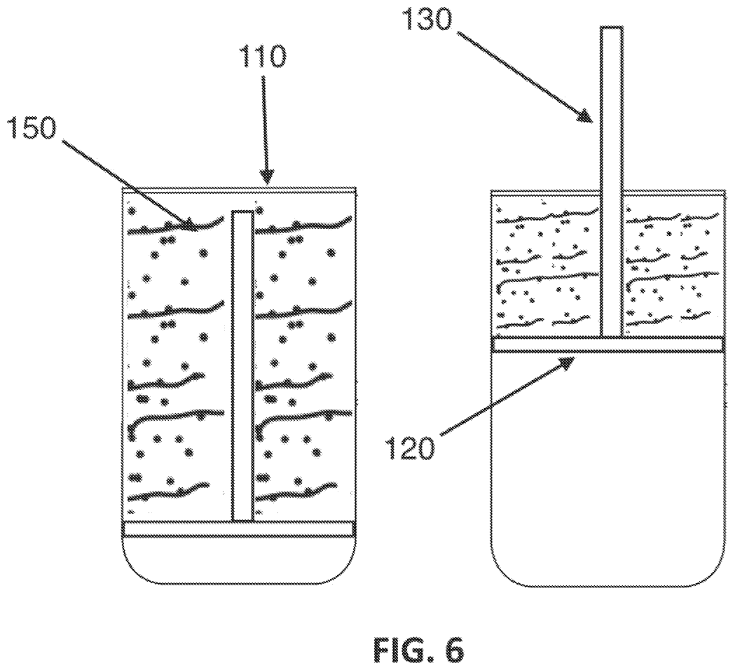

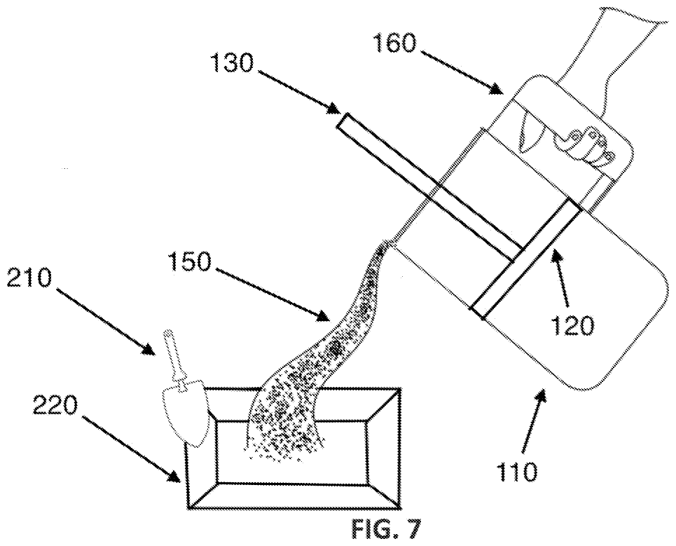

As shown in FIGS. 6 and 7, once the water and joint compound have been mixed in the holding container 110, the user may begin the process of removing the mixed mud, shown as mud 150 in FIGS. 6 and 7. To remove the mud 150, user may grasp and pull rod 130 towards the upper surface of holding container 110, thereby causing plate 120 to also move in harmony with rod 130, ensuring all mud 150 is extracted from holding container 110. Subsequently, mud 150 may be poured onto a receptacle or other container, such as pan 220 as shown in FIG. 7. Once the desired amount of mud 150 is poured into pan 220, user may use a trowel such as trowel 210 or other device to smooth and gather mud 150 from pan 220 for various applications and use (e.g. to cover imperfections and joints on drywall.) In some embodiments, a handle, such as handle 160 shown in FIG. 7, may be attached to holding container to facilitate in the pouring of mud 150.

Holding container 110 may quickly and conveniently be used again and again. For reuse, rod 130 may be pushed back into holding container 110, thus forcing plate 120 back to the bottom of holding container 110. User then may once again pour water and joint compound into holding container 110 for mixing into an additional batch of mud 150. If the user is done mixing water and joint compound into mud 150, the user may replace lid 140 on top of holding container 110 and store for later use. Cleaning is also quick and convenient. To clean holding container 110, fill holding container 110 part way with water, replace lid 140 on top of holding container 110, shake holding container 110, remove lid 140 from holding container 110, eject any leftover remnants from holding container 110, where then mud mixing system 100 may be stored for further use.

In further embodiments, a divider may be inserted into the holding container to separate the joint compound and water, which then may be removed whereby the water and joint compound may be mixed together.

Several advantages are provided by the one or more embodiments for mixing mud herein. The exemplary process of using the mud mixing container and components prevents the user from having to stir the joint compound and water in a pan or using complicated machinery while ensuring a thoroughly mixed mud with minimum effort and labor. Further, it is advantageous to be able to have dry joint compound mixed with water whenever it is suitable and convenient to the user, rather than purchasing the more expensive premixed mud, which also has limitations and disadvantages for its use as described above. The holding container and internal components are easily transported and used at any work site, and may be easily stored without taking too much space.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the use contemplated. The scope of the invention is to be defined by the below claims.

What is claimed is:

1. A method for forming a mud mixture of joint compound and water, the method comprising:
placing the joint compound and the water in a holding container, the holding container having a generally cylindrical shape with an opening at a top, an inner surface, a closed bottom surface, and bore extending through the holding container;
closing a lid, wherein the lid fits securely over the top of the holding container;
shaking the holding container in order to combine the joint compound and the water into a resulting mud mixture;
opening the lid; and
pulling on a rod located within the holding container, wherein the rod is connected to a plate, wherein the plate and the rod are moveable in a reciprocating motion within the holding container.

2. The method of claim 1, further comprising pouring the mud mixture out of the holding container.

3. The method of claim 2, further comprising pouring the mud mixture into a pan.

4. The method of claim 3, further comprising dividing the water and the joint compound with a divider, the divider inserting in the holding container to separate the joint compound and the water.

5. The method of claim 4, further comprising removing the divider.

6. The method of claim 5, cleaning the holding container, wherein the steps to clean the holding container comprise filling the holding container with an amount of the water, replacing the lid on the top of the holding container, shaking the holding container, removing the lid from the holding container, and ejecting any remnants from the holding container.

7. The method of claim 1, wherein the joint compound is a 5 minute, 20 minute, 45 minute, 90 minute powdered mix or dry powdered mixture.

8. The method of claim 1, wherein the plate has a centrally located hole.

9. The method of claim 1, the lid and holding container rotatably movable with respect to another from a first a closed position to an open position whereby the closed position creates a seal preventing liquid from escaping the holding container.

10. The method of claim 1, holding container having a bottom closed end with substantially hemispherical shape.

11. The method of claim 1, an outer diameter of the plate and the inner surface of the holding container forming a static and dynamic seal to prevent leakage between the plate and the holding container.

12. The method of claim 1, the plate made of stainless steel with an outer diameter made of rubber.

13. The method of claim 1, the holding container having a hinge, the hinge connecting the lid the holding container, the hinge having leaves, the leaves connected by a hinge pin inserted through the leaves, one leaf attached to holding container projecting laterally outwardly from the holding container.

14. The method of claim 1, the holding container having a handle, attachable to the holding container.

15. A method for forming a mud mixture of joint compound and water, the method comprising:
placing the joint compound and the water in a holding container;
closing a lid, wherein the lid fits securely over a top of the holding container;
shaking the holding container in order to combine the joint compound and the water into a resulting mud mixture;
opening the lid; and
pulling on a rod located within the holding container, wherein the rod is connected to a plate, wherein the plate and the rod are moveable in a reciprocating motion within the holding container.

16. The method of claim 15, further comprising pouring the mud mixture out of the holding container.

17. The method of claim 16, further comprising pouring the mud mixture into a pan.

18. The method of claim 17, further comprising dividing the water and the joint compound with a divider, the divider inserting in the holding container to separate the joint compound and the water.

19. The method of claim 18, further comprising removing the divider.

20. The method of claim 15, wherein the joint compound is a 5 minute, 20 minute, 45 minute, 90 minute powdered mix.
